(19) United States
(12) Patent Application Publication
(10) Pub. No.: US 2013/0170255 A1
(43) Pub. Date: Jul. 4, 2013

(54) APPARATUS FOR CONTROLLING THE ELECTRIC POWER TRANSMISSION IN A HVDC POWER TRANSMISSION SYSTEM

(71) Applicants: Subhasish Mukherjee, Halisahar (IN); Tomas U Jonsson, Vasteras (SE); Sasitharan Subramanian, Tamil Nadu (IN); Kalpesh Hirjibhai Bhalodi, Bangalore (IN)

(72) Inventors: Subhasish Mukherjee, Halisahar (IN); Tomas U Jonsson, Vasteras (SE); Sasitharan Subramanian, Tamil Nadu (IN); Kalpesh Hirjibhai Bhalodi, Bangalore (IN)

(73) Assignee: ABB TECHNOLOGY AG, Zurich (CH)

(21) Appl. No.: 13/819,751

(22) PCT Filed: Sep. 21, 2010
(86) PCT No.: PCT/EP2010/063881

§ 371 Date: Mar. 18, 2013

(51) Int. Cl. H02M 5/458

(52) U.S. Cl. CPC H02M 5/458
USPC 363/35

(57) ABSTRACT

An apparatus for controlling the electric power transmission in a high voltage direct current, HVDC, power transmission system includes at least one HVDC transmission line for carrying direct current, DC. The apparatus includes a first converter for converting alternating current, AC, to direct current and/or direct current to alternating current, and a second converter for converting direct current to alternating current and/or alternating current to direct current, each of the first and second converters having an AC side for output and/or input of alternating current and a DC side for output and/or input of direct current. The first converter is connectable via its DC side to the HVDC transmission line, the AC side of the second converter is connected to the AC side of the first converter, and the second converter is connectable via its DC side to a DC source. The apparatus is adapted to control the direct current of the HVDC transmission line by introducing a DC voltage in series with the HVDC transmission line. A HVDC power transmission system includes the above-mentioned apparatus.

### TECHNICAL FIELD

The present invention relates to an apparatus for controlling the electric power transmission in a high voltage direct current, HVDC, power transmission system comprising at least one HVDC transmission line for carrying direct current, DC. Further, the present invention relates to a HVDC power transmission system comprising at least one HVDC transmission line for carrying direct current, and a plurality of converter stations connected to the at least one HVDC transmission line, each of the converter stations being adapted to convert alternating current, AC, to direct current for input to the at least one HVDC transmission line, and/or direct current to alternating current, the system comprising an apparatus for controlling the electric power transmission in the system.

### BACKGROUND OF THE INVENTION

A HVDC power distribution network or a HVDC power transmission system uses direct current for the transmission of electrical power, in contrast to the more common AC systems. For long-distance distribution, HVDC systems may be less expensive and may suffer lower electrical losses. In general, a HVDC power transmission system comprises at least one long-distance HVDC link or cable for carrying direct current a long distance, e.g. under sea, and converter stations for converting alternating current to direct current for input to the HVDC power trans-mission system and converter stations for converting direct current back to alternating current.

U.S. Pat. No. 6,788,033 B2 and U.S. Pat. No. 5,734,258 disclose DC to DC conversion and relate to stationary or portable systems powered by a DC battery, and to electric vehicles. U.S. Pat. No. 6,914,420 B2 describes a power converter for converting power between a first and a second voltage, and relates to electric vehicles.

U.S. Pat. No. 7,518,266 B2 discloses an AC power transmission system, where a DC transmission ring is used, utilizing controllable AC-DC converters in a multi-infeed/out-feed arrangement.

U.S. Pat. No. 3,694,728 describes a HVDC mesh-operated network comprising several interconnected stations for effecting an exchange of power by means of converters located at the stations and which are connected to AC networks.

### THE OBJECT OF THE INVENTION

To control the electric power transmission in a HVDC power transmission system comprising at least one HVDC line and a plurality of converter stations for converting between alternating current and direct current in order to avoid or reduce DC load-flow congestion in the system, each of the converter stations may be controlled, e.g. by controlling the DC node voltage of each converter station. However, the inventors of the present invention have found that the DC node voltage control of the converter stations, or the control of shunt connected converter DC voltages of a DC grid, may not be sufficient in order to avoid or reduce load-flow congestion of the system.

The object of the present invention is to improve the electric power trans-mission in a HVDC power transmission system. It is also an object of the present invention to provide an improved control of the electric power transmission in a HVDC power transmission system. A further object of the present invention is to avoid, reduce or prevent load-flow congestion in the system. Another object of the present invention is to provide an improved HVDC power transmission system.

### SUMMARY OF THE INVENTION

The above-mentioned objects of the present invention are attained by providing an apparatus for controlling the electric power transmission in a high voltage direct current, HVDC, power transmission system comprising at least one HVDC transmission line for carrying direct current, DC, wherein the apparatus comprises a first converter for converting alternating current, AC, to direct current and/or direct current to alternating current, and a second converter for converting direct current to alternating current and/or alternating current to direct current, each of the first and second converters having an AC side for output and/or input of alternating current and a DC side for output and/or input of direct current, wherein the first converter is connectable via its DC side to the HVDC transmission line, wherein the AC side of the second converter is connected to the AC side of the first converter, wherein the second converter is connectable via its DC side to a DC source, and wherein the apparatus is adapted to control the direct current of the HVDC transmission line by introducing a DC voltage in series with the HVDC transmission line.

By the innovative apparatus of the present invention, the electric power transmission in a HVDC power transmission system and the control thereof are efficiently improved, and load-flow congestion in the system may be avoided, reduced or prevented. The AC side of the second converter may be adapted to provide, directly or indirectly, alternating current to the AC side of the first converter, and/or vice versa

The apparatus of the present invention is especially advantageous and efficient for a HVDC power transmission system of the sort shown in FIG. 1, which may be called a DC grid concept, where the system comprises several HVDC transmission lines for carrying direct current and several converter stations connected to the HVDC transmission lines. The apparatus of the present invention is especially advantageous when the control of DC node voltage of the converter stations, or the control of shunt connected converter DC voltages of a DC grid, is not sufficient. By the apparatus of the present invention, the direct current of the HVDC transmission line, to which the apparatus is connected, can be increased or reduced in order to control the power transmission. The direct current control is attained by the apparatus' introduction, or injection, of a DC voltage in series with the HVDC transmission line. The injected DC voltage produces a fictive resistance, ΔRᵢₙⱼ. The fictive resistance provides an active power extraction or output from the HVDC transmission line when the fictive resistance corresponds to an increase in resistance, i.e. a positive ΔRᵢₙⱼ, (since a resistance consumes power/energy), or an active power input to the HVDC transmission line when the fictive resistance corresponds to a decrease in resistance, i.e. a negative ΔRᵢₙⱼ. A positive ΔRᵢₙⱼ is produced when the apparatus introduces a positive DC voltage in series with the HVDC transmission line, and a negative ΔRᵢₙⱼ is produced when the apparatus introduces a negative DC voltage in series with the HVDC transmission line. Thus, by the apparatus of the present invention, the load of the HVDC trans-mission line, to which the apparatus is connected, may be reduced or increased. The apparatus' active power extraction or output from the HVDC transmission line results in a decrease in direct current of the line, and the apparatus' active power input to the HVDC transmission line results in an increase in direct current of the line. By the increase and decrease in direct current of HVDC transmission line, the power transmission is controlled and load-flow congestion may be avoided, reduced or prevented. Thus, the apparatus of the present invention is adapted to regulate the voltage at its output to control the current flow in the HVDC transmission line.

In alternative words, the apparatus according to the present invention is adapted to control the direct current of the HVDC transmission line by introducing a fictive resistance in series with the HVDC transmission line by introducing a DC voltage in series with the HVDC transmission line.

Further, the direct current in a HVDC power transmission system, e.g. a DC grid system, may reverse, and therefore, voltage polarity reversal for maintained fictive resistance is required, which is also attained by the apparatus of the present invention. Further, the apparatus of the present invention has the capability to operate in all the four quadrants, which is discussed in more detail in the detailed description of preferred embodiments.

The various components of the apparatus of the present invention, which are connected or connectable to one another or to other units, may be electrically connected, or connectable, to one another or to other units, e.g. via electrical conductors, e.g. busbars or DC lines, and/or may be indirectly connected, or connectable, e.g. electrically or inductively, via additional intermediate electric equipment or units located and connected/connectable between the components, e.g. a transformer, another converter etc.

In general, High Voltage may be about 1-1.5 kV and above. However, for HVDC applications and systems, High Voltage may be about 500 kV and above, e.g. 800 kV or 1000 kV, and above. The apparatus and/or the system according to the present invention are advantageously adapted for the above-mentioned HVDC voltage levels and above. The voltage rating of the apparatus may be 1-5% of the HVDC transmission line voltage.

According to an advantageous embodiment of the apparatus according to the present invention, the apparatus comprises control means for controlling the apparatus, wherein the control means are adapted to control the apparatus to introduce a positive DC voltage in series with the HVDC transmission line for reducing the direct current of the HVDC transmission line, and wherein the control means are adapted to control the apparatus to introduce a negative DC voltage in series with the HVDC transmission line for increasing the direct current of the HVDC transmission line. By the control means of this embodiment, the current flow in the HVDC transmission line is efficiently controlled. The control means may be in form of a control unit and may be connectable to the HVDC power transmission system, e.g. to the HVDC transmission line. The control means may comprise a computer and/or a CPU. In alternative words, the control means may be adapted to control the apparatus to introduce a positive fictive resistance in series with the HVDC transmission line by introducing a positive DC voltage in series with the HVDC transmission line for reducing the direct current of the HVDC transmission line, and the control means may be adapted to control the apparatus to introduce a negative fictive resistance in series with the HVDC transmission line by introducing a negative DC voltage in series with the HVDC transmission line for increasing the direct current of the HVDC transmission line.

According to a further advantageous embodiment of the apparatus according to the present invention, the apparatus comprises measuring means for measuring the DC load flow congestion of the HVDC power transmission system, and the measuring means are adapted to communicate with the control means. The measuring means may be adapted to measure the direct current or direct voltage of the HVDC line, and the measuring means per se may have a structure known the person skilled in the art. The measuring means, or measuring equipment, may comprise conventional sensors, e.g. sensors for measuring direct current or voltage.

According to another advantageous embodiment of the apparatus according to the present invention, the apparatus comprises a bypass switch connectable to the HVDC transmission line and connected in parallel with the first converter, and when closed the bypass switch is adapted to conduct the direct current of the HVDC transmission line to electrically bypass the first converter. By the bypass switch, the first converter, and the apparatus, may be bypassed during fault conditions, whereby the electric power transmission in a HVDC power transmission system and the control thereof are further improved.

According to yet another advantageous embodiment of the apparatus according to the present invention, the apparatus comprises the DC source to which the second converter is connected via its DC side. To effect or introduce a positive fictive resistance, +ΔRᵢₙⱼ, active power should be absorbed by the DC source, and to effect or introduce a negative fictive resistance, −ΔRᵢₙⱼ, active power should be injected by and from the DC source.

According to still another advantageous embodiment of the apparatus according to the present invention, the apparatus is adapted to be connected to a DC source comprising a first cascaded half-bridge cell, to which the second converter is connectable via its DC side. The cascaded half-bridge cell (also called Cascaded Two-Level, CTL, cell) may be provided by a cascaded full-bridge cell. A cascaded half-bridge cell and a cascaded full-bridge cell per se and their structure are well known to the person skilled in the art and therefore not disclosed or discussed in more detail. The DC source may comprise a capacitor. The inventors of the present invention have found that the use of a cascaded half-bridge cell for the DC source efficiently improves the electric power transmission in a HVDC power transmission system and the control thereof.

According to an advantageous embodiment of the apparatus according to the present invention, the first cascaded half-bridge cell is adapted to be part of a converter station included in the HVDC power transmission system, the converter station being adapted to convert alternating current to direct current, for input to the HVDC transmission line, and/or direct current to alternating current. It is known to the skilled person that converter stations in HVDC power transmission system comprise cascaded half-bridge cells. By using a cascaded half-bridge cell present in a converter station, the efficiency of the apparatus is further improved. By using a cascaded half-bridge cell already present in a converter station, the manufacturing costs of the apparatus of the present invention are kept at a low level. However, an extra cascaded half-bridge cell, designated for the apparatus, may also be added to be part of a converter station.

According to a further advantageous embodiment of the apparatus according to the present invention, the apparatus is adapted to be connected to a DC source comprising a plurality of cascaded half-bridge cells to which the first cascaded half-bridge cell is connectable. The inventors of the present invention have found that the use of several cascaded half-bridge cells efficiently improves the flexibility and efficiency of the electric power transmission in a HVDC power transmission system and the control thereof. With reference to the above, the plurality of cascaded half-bridge cells may be provided by a plurality of cascaded full-bridge cells, or a mixture thereof.

According to another advantageous embodiment of the apparatus according to the present invention, the plurality of cascaded half-bridge cells are adapted to be part of a converter station included in the HVDC power transmission system. The converter station may also comprise cascaded full-bridge cells or a mixture of cascaded half-bridge cells and cascaded full-bridge cells.

According to yet another advantageous embodiment of the apparatus according to the present invention, the apparatus is adapted to be connected to a DC source comprising an electric battery. The inventors of the present invention have found that the use of an electric battery for the DC source efficiently improves the electric power transmission in a HVDC power transmission system and the control thereof. However, other suitable DC sources may be used. The DC source may for example comprise photovoltaic cells and/or flywheels etc.

According to still another advantageous embodiment of the apparatus according to the present invention, the apparatus is adapted to be connected to a DC source being part of a HVDC grid. The inventors of the present invention have found that the use of a DC source being part of a HVDC grid provides efficient electric power transmission in a HVDC power transmission system and an efficient control thereof.

According to yet another advantageous embodiment of the apparatus according to the present invention, the second converter comprises a Voltage Source Converter, VSC. By this embodiment the electric power transmission in a HVDC power transmission system and the control thereof are further improved.

According to still another advantageous embodiment of the apparatus according to the present invention, the second converter comprises four pairs of electronic control devices, each pair of electronic control devices comprising an electronic control switch and a diode. The electronic control devices may be connected to one another. The inventors of the present invention have found that this structure of the second converter further improves the flexibility and efficiency of the electric power transmission in a HVDC power transmission system and the control thereof.

According to an advantageous embodiment of the apparatus according to the present invention, the first converter comprises a full-bridge converter. The inventors of the present invention have found that this structure of the second converter further improves the flexibility and efficiency of the electric power transmission in a HVDC power transmission system and the control thereof. The first converter may comprise a full-bridge converter with a bypass switch.

According to a further advantageous embodiment of the apparatus according to the present invention, the apparatus comprises an electric power trans-former connected between the first and second converters, and each of the first and second converters is connectable via its AC side to the electric power transformer. By the electric power transformer, the flexibility and efficiency of the electric power transmission in a HVDC power transmission system and the control thereof are further improved. The electric power transformer may also be part in fulfilling the voltage requirements of the apparatus. The electric power transformer may be in the form of a high frequency electric power transformer.

According to a further advantageous embodiment of the apparatus according to the present invention, the electric power transformer is adapted to isolate the first converter from the DC source. By this embodiment, the HVDC transmission line, to which the apparatus is connected, is also efficiently isolated from the DC source.

According to another advantageous embodiment of the apparatus according to the present invention, the second converter is adapted to convert DC voltage to high frequency AC voltage. Advantageously, the electric power transformer may be a high frequency transformer. By this embodiment, the electric power transmission in a HVDC power transmission system and the control thereof are further improved.

According to yet another advantageous embodiment of the apparatus according to the present invention, the first converter comprises four pairs of electronic control switches. The electronic control switches may be connected to one another. The inventors of the present invention have found that this structure of the first converter further improves the flexibility and efficiency of the electric power transmission in a HVDC power transmission system and the control thereof. Advantageously, the first converter may also comprise a fifth pair of electronic control switches. Each electronic control switch of the fifth pair may comprise a transistor. The fifth pair of electronic control switches may be connected in parallel with the four pairs of electronic control switches. Alternatively, and especially if the apparatus does not include an electric power transformer, the first converter may comprise one pair of electronic control switches.

According to still another advantageous embodiment of the apparatus according to the present invention, the first converter comprises filter means for smoothing out the voltage and current ripple caused by the switching of the electronic control switches. The filter means may be connected to the electronic control switches. By smoothing out the voltage and current ripple, a further improved control of the electric power transmission is attained. The filter means, or filter components, may comprise a capacitor and an inductor. The capacitor may be connected in parallel with the electronic control switches. The inductor may be connected in series with the electronic control switches. By the above-mentioned embodiments of the filter means, a further improved control of the power transmission is provided.

According to an advantageous embodiment of the apparatus according to the present invention, each electronic control switch comprises a transistor, e.g. an Insulated Gate Bipolar Transistor, IGBT, or a Bi-Mode Insulated Gate Transistor, BIGT, or any other suitable transistor. Alternatively, each electronic control switch may also comprise a thyristor, e.g. a gate turn-off thyristor, GTO, an Integrated Gate-Commutated Thyristor, IGCT, or a Forced Commutated Thyristor. However, other suitable thyristors may also be used. The inventors of the present invention have found that these structures of first and/or second converter further improves the flexibility and efficiency of the electric power transmission in a HVDC power transmission system and the control thereof.

According to another advantageous embodiment of the apparatus according to the present invention, the first converter is connectable in series with the HVDC transmission line.

According to yet another advantageous embodiment of the apparatus according to the present invention, the apparatus is adapted for four quadrant operation. Aspects of the four quadrant operation are disclosed in the detailed description of preferred embodiments. Advantageously, the apparatus may be adapted for one quadrant operation, two quadrant operation or three quadrant operation, where the quadrant operation/-s may be any of the first to fourth quadrant operations e.g. as disclosed in the detailed description of preferred embodiments. The one, two or three quadrant operation may be attained by replacing suitable IGBT/IGBTs with diode/diodes of a four quadrant converter.

The above-mentioned objects of the present invention are also attained by providing a high voltage direct current, HVDC, power transmission system comprising at least one HVDC transmission line for carrying direct current, DC, and a plurality of converter stations connected to the at least one HVDC transmission line, each of the converter stations being adapted to convert alternating current, AC, to direct current for input to the at least one HVDC transmission line, and/or direct current to alternating current, wherein the system comprises at least one apparatus as claimed in any of the claims 1-19 for controlling the electric power transmission in the system, and/or at least one apparatus according to any of the above-mentioned embodiments of the apparatus. Positive technical effects of the HVDC power transmission system according to the present invention, and its embodiments, correspond to the above-mentioned technical effects mentioned in connection with the apparatus according to the present invention, and its embodiments. The at least one HVDC transmission line may be one or a plurality of HVDC transmission lines

According to an advantageous embodiment of the HVDC power transmission system according to the present invention, the system comprises a plurality of HVDC transmission lines.

A plurality of HVDC transmission lines or converter stations may be two or more HVDC transmission lines or converter stations, respectively. The at least one apparatus may be one or a plurality of apparatuses, e.g. two or more apparatuses. A plurality of apparatuses may be connected to the same HVDC transmission line, or to different HVDC transmission lines. For example, two apparatuses adapted for two quadrant operation may be connected to the same HVDC transmission line to attain four quadrant operation.

According to an advantageous embodiment of the HVDC power transmission system according to the present invention, the system comprises at least three converter stations. Advantageously, the system comprises at least four converter stations, or at least five converter stations.

According to a further advantageous embodiment of the HVDC power transmission system according to the present invention, the at least one HVDC transmission line comprises at least one long-distance HVDC link or cable. Advantageously, the HVDC transmission lines may comprise at least two long-distance HVDC links or cables.

The above-mentioned embodiments and features of the apparatus and the HVDC power transmission system, respectively, according to the present invention may be combined in various possible ways providing further advantageous embodiments.

Further advantageous embodiments of the apparatus and the HVDC power transmission system, respectively, according to the present invention and further advantages with the present invention emerge from the detailed description of embodiments.

### BRIEF DESCRIPTION OF THE DRAWINGS

The present invention will now be described, for exemplary purposes, in more detail by way of embodiments and with reference to the enclosed drawings, in which:

FIG. 1 is a schematic block diagram illustrating aspects of the HVDC power transmission system and aspects of the apparatus according to the present invention;

FIG. 2A is schematic block diagram illustrating a first embodiment of a converter station shown in FIG. 1;

FIG. 2B is schematic block diagram illustrating a second embodiment of a converter station shown in FIG. 1;

FIG. 3 is a schematic block diagram illustrating a first embodiment of the apparatus according to the present invention;

FIG. 4 is a schematic diagram illustrating aspects of the apparatus of FIG. 3 in more detail;

FIG. 5 is a schematic diagram illustrating the four quadrant operation of the apparatus of FIG. 4;

FIG. 6 is a schematic diagram illustrating an equivalent circuit for first quadrant operation of the apparatus of FIG. 4;

FIG. 7 is a schematic graph illustrating the first quadrant operation of the apparatus of FIG. 4;

FIG. 8 is a schematic graph illustrating the second quadrant operation of the apparatus of FIG. 4;

FIG. 9 is a schematic diagram illustrating a second embodiment and further aspects of the apparatus according to the present invention;

FIGS. 10A and 10B are schematic diagrams illustrating alternative electronic control devices; and

FIGS. 11 and 12 are schematic diagrams illustrating further embodiments of the apparatus according to the present invention.

### DETAILED DESCRIPTION OF PREFERRED EMBODIMENTS

### Abbreviations

### Alternating Current AC

### Bi-Mode Insulated Gate Transistor BIGT

### Direct Current DC

### Central Processing Unit CPU

Gate Turn-Off thyristor GTO

### High Voltage Direct Current HVDC

### Insulated Gate Bipolar Transistor IGBT

### Integrated Gate-Commutated Thyristor IGCT

### Pulse Width Modulation PWM

### Voltage Source Converter VSC

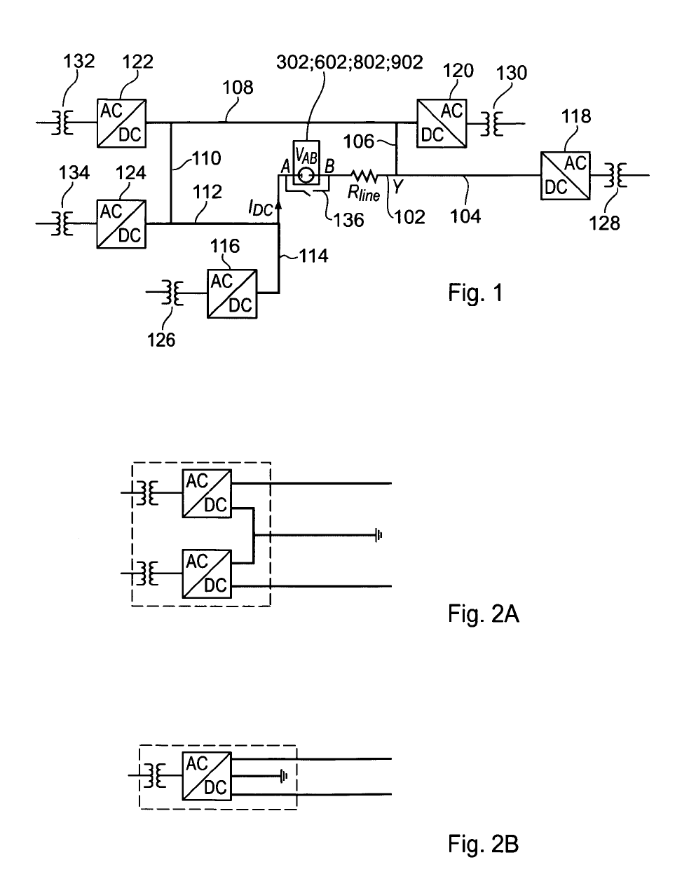

FIG. 1 schematically shows aspects of the HVDC power transmission system and aspects of the apparatus 302, 602 according to the present invention. The HVDC power transmission system comprising a plurality of HVDC transmission lines 102, 104, 106, 108, 110, 112, 114 for carrying direct current. The HVDC transmission lines may e.g. comprise HVDC cables, busbars, or other DC conductors. The HVDC transmission lines may comprise at least one long-distance HVDC link. In FIG. 1, a first and second long-distance HVDC link 102, 108 are provided. HVDC transmission lines and links are well known to the skilled person and thus not discussed in further detail. The HVDC power transmission system comprises a plurality of converter stations 116, 118, 120, 122, 124 electrically connected to the HVDC transmission lines 102, 104, 106, 108, 110, 112, 114. In FIG. 1, five converter stations 116, 118, 120, 122, 124 are provided, but there may be more or fewer converter stations. Each of the converter stations may be adapted to convert alternating current to direct current for input to the transmission lines and convert direct current to alternating current for input to neighbouring AC systems. Each converter station 116, 118, 120, 122, 124 may be electrically connected to a conventional electric power transformer 126, 128, 130, 132, 134 in conventional ways known to the skilled person. Electric power transformers and their function are well known to the person skilled in the art and therefore not discussed in more detail. Each converter station, which may be called a DC Grid converter station, may have asymmetrical monopoles with separate converters for positive and negative polarity, as illustrated in FIG. 2A. Alternatively, each converter station may be in the form of a balanced bipolar converter, as illustrated in FIG. 2B. The alternatives of FIGS. 2A and 2B may also be combined in the same system. The apparatus 302, 602, 802, 902 according to the present invention is adapted to be electrically connected to the HVDC system, e.g. by being connected between positions A and B as illustrated in FIG. 1. However, other locations and connections points are possible, and the apparatus may e.g. be connected to any of the other HVDC transmission lines. Rₗᵢₙₑ of the HVDC transmission line 102 in FIG. 1 illustrates the resistance of the line 102, and I_{DC} in FIG. 1 is the direct current through the line 102, i.e. the direct current carried by the line 102. The HVDC power transmission system may be adapted for single phase power or multi-phase power, e.g. three-phase power, and the components of the system and the apparatus may be configured accordingly in ways known to the skilled person. The HVDC power transmission system comprises an embodiment of the apparatus 302, 602, 802, 902 for controlling the electric power transmission in the system according to the present invention, and aspects of the apparatus 302, 602 will hereinafter be disclosed.

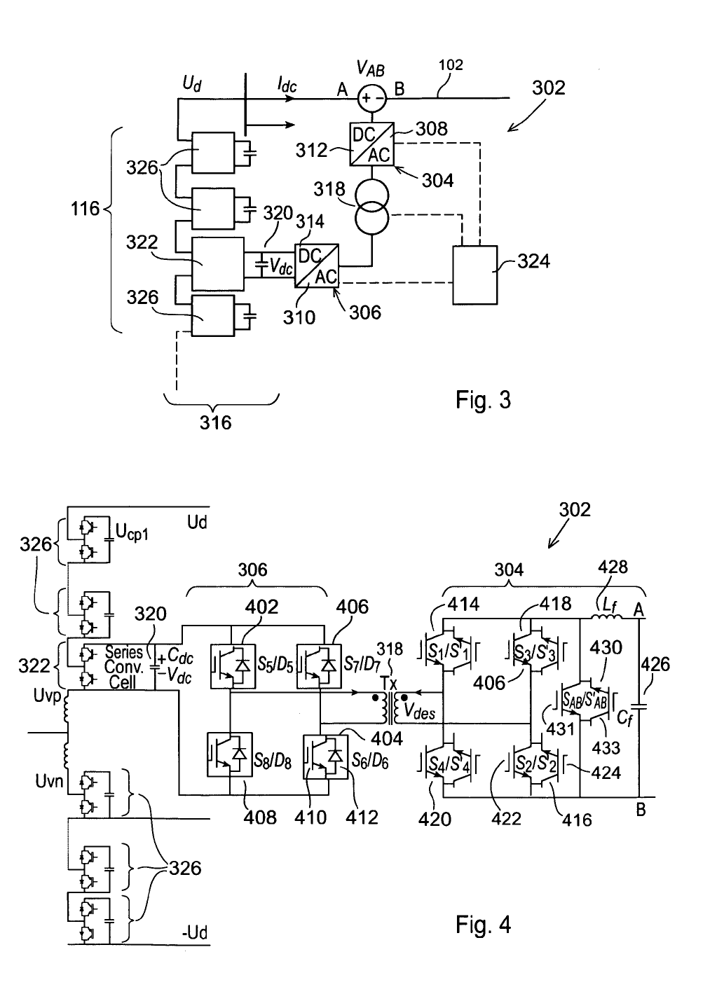

The apparatus 302, 602, 802, 902 may comprise a bypass switch 136 (see FIG. 1) electrically connectable to the HVDC transmission line 102 to which the apparatus 302, 602, 802, 902 is connected and electrically connected in parallel with a first converter 304, 604, 804, 904 (see FIGS. 3, 4, 9, 11 and 12) of the apparatus 302, 602, 802, 902. When the bypass switch 136 is closed, it is adapted to conduct the direct current of the HVDC transmission line to electrically bypass the first converter 304, 604, 804, 904. By the bypass switch 136, the first converter 304, 604, 804, 904 and the apparatus 302, 602, 802, 902 may be bypassed during fault conditions.

FIG. 3 schematically shows a first embodiment of the apparatus according power transmission system, e.g. as shown in FIG. 1. The apparatus comprises a to the present invention for controlling the electric power transmission in a HVDC first converter 304 for converting alternating current to direct current and/or direct current to alternating current, and a second converter 306 for converting direct current to alternating current and/or alternating current to direct current. Each of the first and second converters 304, 306 has an AC side 308, 310 for output and/or input of alternating current and a DC side 312, 314 for output and/or input of direct current. The first converter 304 is electrically connectable via its DC side 312 to the HVDC transmission line 102, and the first converter 304 may be electrically connectable in series with the HVDC transmission line 102. The AC side 308 of the first converter 304 is connected to the AC side 310 of the second converter 306. The second converter 306 is connectable via its DC side 314 to a DC source 316, which will be disclosed in more detail hereinafter. The apparatus 302 may comprise the DC source 316. The apparatus 302 may also comprise an electric power transformer 318, also indicated as Tₓ in FIG. 4, connected between the first and second converters 304, 306, each of the first and second converters 304, 306 being electrically connectable, or connected, via its AC side 308, 310 to the electric power transformer 318. The electric power transformer 318 may be a high frequency transformer, and the second converter 306 may be adapted to convert DC voltage to high frequency AC voltage. The electric power transformer 318 may be adapted to isolate the first converter 304 from the DC source 316, and may thus also be adapted to isolate the HVDC line 102 from the DC source 316. The DC source 316 may comprise an apparatus cell capacitor 320, also indicated as C_{dc} in FIG. 4, to which the second converter 306 is electrically connectable via its DC side 314. The DC source 316 may comprise a first cascaded half-bridge cell 322, to which the apparatus cell capacitor 320 may be connected. Instead of a first cascaded half-bridge cell 322, a first cascaded full-bridge cell may be used. The structure of the first cascaded half-bridge cell 322 may correspond to the structure of conventional cascaded half-bridge cells and is well known to the skilled person and therefore not discussed in more detail.

The apparatus 302 is adapted to control the direct current of the HVDC transmission line 102 by introducing a DC voltage V_{AB} in series with the HVDC transmission line 102. The apparatus 302 may comprise control means 324, e.g. a computer or CPU, for controlling the apparatus and its various components. The control means 324 are adapted to control the apparatus 302 to introduce a positive DC voltage, V_{AB}>0, in series with the HVDC transmission line 102 for reducing the direct current, i.e. I_{DC}, of the HVDC transmission line 102, and the control means 324 are adapted to control the apparatus 302 to introduce a negative DC voltage, V_{AB}<0, in series with the HVDC transmission line 102 for increasing I_{DC} of the HVDC transmission line 102. The above-mentioned fictive resistance ΔRᵢₙⱼ may be defined by the following expression: ΔRᵢₙⱼ=V_{AB}/I_{DC}.

The first cascaded half-bridge cell 322 may be adapted to be part of a converter station 116 included in the HVDC power transmission system, e.g. as illustrated in FIG. 1. The DC source 316 may comprise a plurality of cascaded half-bridge cells 326, to which the first cascaded half-bridge cell 322 may be connectable, and the plurality of cascaded half-bridge cells 326 may also be adapted to be part of the converter station 116. Any of the plurality of cascaded half-bridge cells may form the first cascaded half-bridge cell to which the apparatus 302 is adapted to be connected, i.e. the apparatus may be connected to any of the cascaded half-bridge cells 326 instead of the first cascaded half-bridge cell 322 as indicated in FIGS. 3 and 4. Instead of a plurality of cascaded half-bridge cells, a plurality of cascaded full-bridge cells, or a mixture thereof, may be used. The apparatus may be connected to any one or a plurality of the converter stations 116, 118, 120, 122, 124 of a HVDC power transmission system. The structure of a conventional converter station and how it is built up of cascaded half-bridge cells 322, 326 are well known to the skilled person.

With reference to FIG. 4, aspects of the apparatus of FIG. 3 are schematically illustrated in more detail. The second converter 306 may comprise a VSC and may comprise four pairs 402, 404, 406, 408, also indicated as S₅/D₅, S₆/D₆, S₇/D₇, S₈/D₈ in FIG. 4, of electrically interconnected electronic control devices 410, 412. Each pair of electronic control devices 410, 412 may comprise an electronic control switch 410 and a diode 412. The first converter 304 may comprise a full-bridge converter. The first converter 304 may comprise four pairs 414, 416, 418, 420, also indicated as S₁/S₁′, S₂/S₂′, S₃/S₃′, S₄/S₄′ in FIG. 4, of electrically interconnected electronic control switches 422, 424. The first converter 304 may also comprise a fifth pair 430 of electronic control switches 431, 433, also indicated as S_{AB}/S′_{AB}. The fifth pair 430 of electronic control switches may be electrically connected in parallel with the four pairs 414, 416, 418, 420 of electronic control switches. The first converter 304 may comprise filter means 426, 428 connected to the electronic control switches 422, 424, for smoothing out the voltage and current ripple caused by the switching of the electronic control switches 422, 424. The filter means may comprise a capacitor 426, also indicated as C_{f} in FIG. 4, and an inductor 428, also indicated as L_{f}. The capacitor 426 may be connected in parallel with the electronic control switches 422, 424. The inductor 428 may be electrically connected in series with the electronic control switches 422, 424. The capacitor 426 may be connected in parallel with the fifth pair 430 of electronic control switches.

The filter inductor 428 may be connected in series with the first converter DC terminal with a first end connected to the common point of 414, 418 and 430, and with the a second end connected to the filter capacitor 426. The other end of the filter capacitor 426 may be connected to the common point of 420, 416 and 430. This connection may also be reversed, i.e. the first end of the filter inductor 428 may be connected to the common point of 420, 416 and 430, and the second end of the filter inductor 428 may be connected to the filter capacitor 426. The other end of the filter capacitor 426 may be connected to the common point of 414, 418 and 430.

The four quadrant operation of the apparatus may be supported by bi-directional valves. By introducing PWM switching, the injected voltage V_{AB} may be regulated to a desired value or level in an efficient way. PWM switching per se is well known to the skilled person and is thus not discussed in further detail. The power requirement of first converter 304 is supplied from the second converter 306 connected via the electric power transformer 318. The VSC of the second converter 306 may comprise at least two legs which convert direct current to alternating current and/or vice-versa. To effect or introduce a positive fictive resistance, +ΔRᵢₙⱼ, active power should be absorbed by the DC source, and to effect or introduce a negative fictive resistance, −ΔRᵢₙⱼ, active power should be injected by and from the DC source. To maintain the DC voltage V_{dc} of the apparatus cell capacitor 320, the active power should be exchanged between the apparatus cell capacitor 320 and the converter station 116 to which the apparatus 302 is connected. The power exchange may be attained by the converter station cell voltage control. The first cascaded half-bridge cell 322, which is connected to the apparatus 302, may have more voltage variations compared to the other cascaded half-bridge cells 326 of the converter station 116. By using a cascaded half-bridge cell already present in a converter station 116, the manufacturing costs of the apparatus 302 of the present invention are kept at a low level. However, an extra cascaded half-bridge cell, to which the apparatus is connectable, may also be added to be part of a converter station 116. If an extra cascaded half-bridge cell is not added, the operation control of the converter station 116 is altered, whereas if an If an extra cascaded half-bridge cell is added, the operation control of the converter station 116 may be unchanged. The apparatus may be floating above the ground potential, and suitable insulation for the apparatus may be provided.

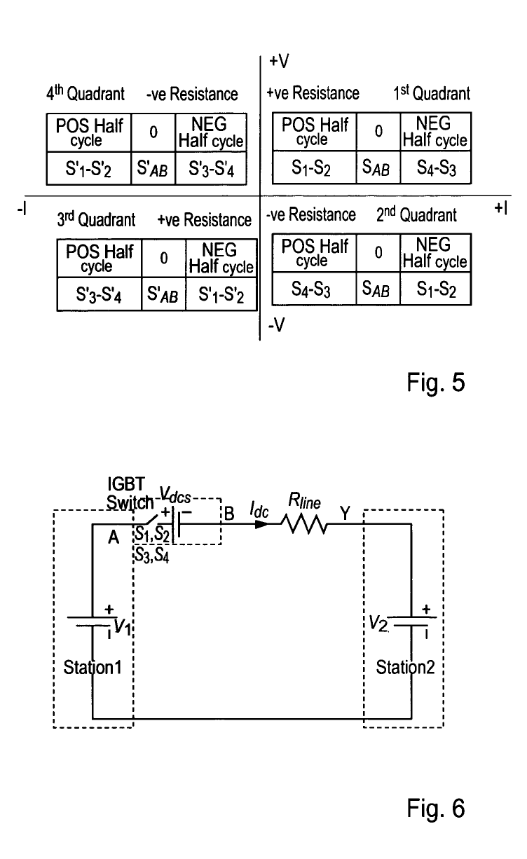

With reference to FIGS. 5-8, aspects of the four quadrant operation of the apparatus of FIG. 4 will now be illustrated. As mentioned above, the apparatus 302 can operate in all the four quadrants as shown in FIG. 5, the voltage and current polarity being as shown in FIG. 1, 3 or 4. In the first quadrant operation, the HVDC line current is flowing from position A to position Y (see FIG. 1). Since the voltage/potential in position A is greater than in position B, the switches S₁, S₂, S₃, S₄ are forward-biased. The equivalent circuit for the first quadrant operation is illustrated in FIG. 6, where V₁ is the voltage in position A, V₂ is the voltage at station 2, which correspond to a converter station on the right side in FIG. 3 (station 1 in FIG. 6 corresponds to a converter station on the left side in FIG. 3), and V_{dcs} is the trans-former secondary voltage. To assure forward-biasing for the transistor (e.g. IGBT) switches, the voltage across the transistor switches should be positive. Kirchoff's voltage law for the first quadrant operation is given as

V₁−V₂−V_{dcs}>0

This implies that V₁−V₂>V_{dcs}, and the voltage across the transistor is positive. When V_{IGBT}>0, the transistor switches are forward-biased and the transistor switches may be turned ON. When V_{IGBT}<0, the transistor switches are reverse-biased and the transistor switches may not be turned ON.

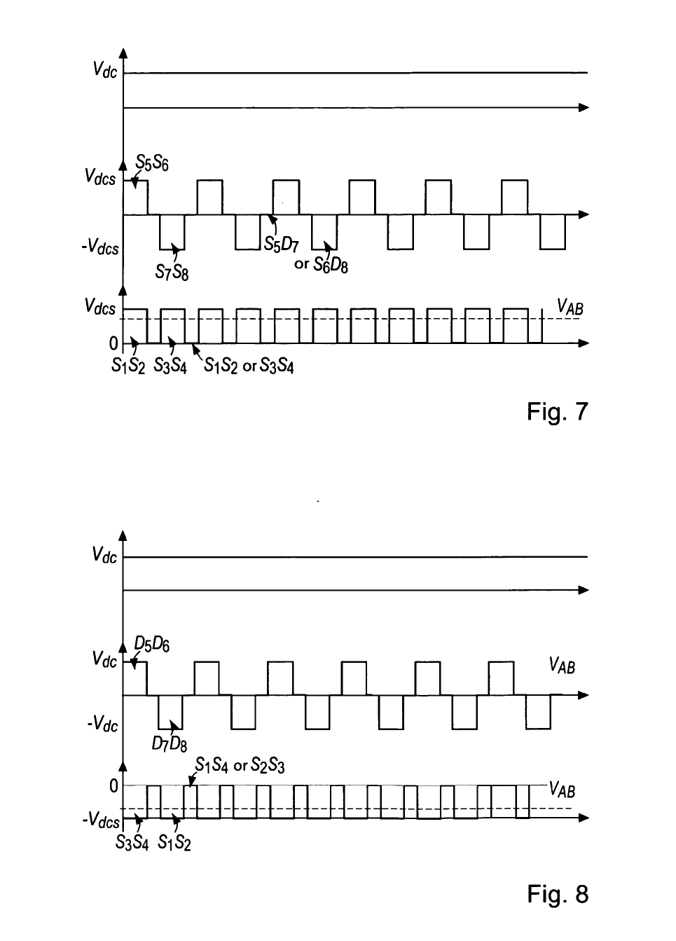

If transistor switches S₁, S₂ are turning ON at positive half cycle and transistor switches S₃, S₄ are turning ON during negative half cycle, the output voltage across the positions A-B will be the DC voltage V_{dcs}. To regulate the injected voltage to the HVDC line 102, zero voltage is inserted by bypassing the DC source at the first converter 304 as illustrated in FIG. 7. In the first converter 304, bypassing can be effected by turning ON the transistor S_{AB}. In the second converter 306, the DC capacitor C_{dc} is bypassed through S₅, D₇ or S₆, D₈. With appropriate duty ratio the voltage across the positions A-B may be controlled to give desired positive resistance.

During the second quadrant operation, to get negative voltage across the positions A-B, transistors S₃, S₄ are turned ON for positive half cycle and transistors S₁, S₂ are turned ON during negative half cycle. The bypass path S_{AB} in the first converter 304 is used to achieve zero voltage across the positions A-B. The switches D₅-D₆ or D₇-D₈ are forward-biased in the second converter 306 since there is a voltage difference between the positions A-B. The voltage across the positions A-B (V_{AB}) may be regulated by PWM operation as shown in FIG. 8. The PWM voltage may be averaged by the filter means and injected in series with the HVDC line 102. If the duty ratio is increased, the voltage V_{AB} will be more negative and a “negative” resistance, i.e. a decrease in resistance, is introduced in the HVDC line 102. Since V₁−V₂>−V_{dcs} is always true for the second quadrant, the forward-biased condition for the first converter 304 is fulfilled. However, it may not true for the second converter 306 since the DC polarity is reversed with respect to the first converter 304. Thus, the condition for forward-biasing may be given as

nV₁−nV₂>V_{dc},

where n is the transformation ratio of the transformer 318. The above condition may be rewritten on the secondary side as

V₁−V₂>V_{dcs}

Thus, the same condition is implied on the second quadrant operation. The third and fourth quadrant operations correspond to the first and second quadrant operations but with opposite current direction.

As mentioned above, one extra cascaded half-bridge cell may be added in a converter stations to be assigned to the apparatus 302. The extra cascaded half-bridge cell, which may form the first cascaded half-bridge cell 322, may be connected at any point between DC bus and midpoint in any phase leg. Ratings of the extra cell may correspond to the other cascaded half-bridge cells of the converter stations. During the first and third quadrant operations of the first converter 304, the voltage V_{dc} of the apparatus cell capacitor 320 may increase more than the nominal value. To maintain the voltage of the apparatus cell capacitor 320, the extra power may be removed by appropriately connecting the apparatus cell capacitor 320 at the leg current path (the extra cascaded half-bridge cell capacitor energy should be discharged by the leg current). During the second and the fourth quadrant operations of the apparatus 302, the voltage V_{dc} of the apparatus cell capacitor 320 may decrease below the nominal value. Thus, the energy of the apparatus cell capacitor 320 is replenished by the apparatus operation. Without affecting the output voltage quality on AC side and DC side, the voltage of the first cascaded half-bridge cell 322 may be maintained at nominal value, which is possible by the cascaded half-bridge cell voltage control and power balance equations.

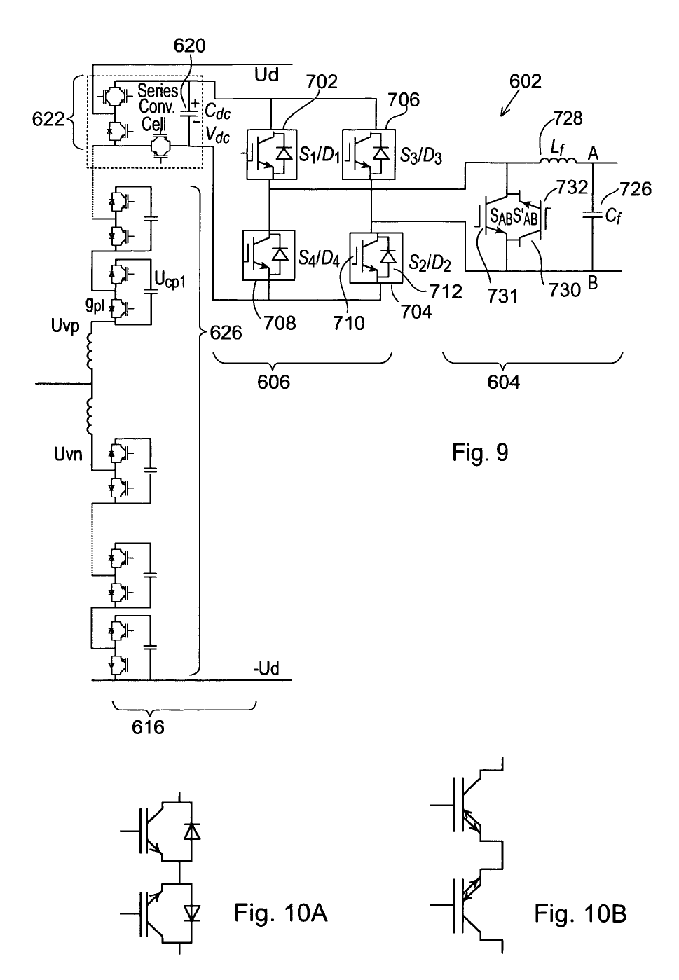

FIG. 9 schematically shows a second embodiment and further aspects of the apparatus 602 according to the present invention for controlling the electric power transmission in a HVDC power transmission system, e.g. as shown in FIG. 1. The second converter 606 of this embodiment generally corresponds to the second converter 306 of the first embodiment of FIGS. 3 and 4 and comprises four pairs 702, 704, 706, 708, also indicated as S₁/D₁, S₂/D₂, S₃/D₃, S₄/D₄ in FIG. 9, of electrically interconnected electronic control devices 710, 712. Each pair of electronic control devices 710, 712 may comprise an electronic control switch 710 and a diode 712. Here, the first converter 604 is electrically connected to the second converter 606 without any intermediate isolation transformer. The first converter 604 may comprise a capacitor 726, also indicated as C_{f} in FIG. 9, an inductor 728, also indicated as L_{f} in FIG. 9, and a pair 730 of electronic control switches 731, 732, also indicated as S_{AB}/S′_{AB}. The capacitor 726 may be connected in parallel with the electronic control switches 731, 732. The inductor 728 may be electrically connected in series with the electronic control switches 731, 732. The Isolation trans-former may be omitted by operating the apparatus 602 for only 50% duty cycle i.e. only 50% of the time the apparatus cell capacitor 620 is connected to the first converter 604. The remaining 50% of the time is used for exchanging power between the apparatus cell capacitor 620 and the converter station 116 to which the apparatus 602 is connected. Since there no isolation transformer present, bi-directional switches are advantageously provided in the first cascaded half-bridge cell 622, to which the apparatus 602 is connected, in order to avoid unwanted connection during operation of the first converter 604. If the first cascaded half-bridge cell 622 is connected at the top of the phase leg as shown in FIG. 9, the cell voltage ratings of the first cascaded half-bridge cell 622 will correspond to the cell voltage ratings of the other cascaded half-bridge cells 626. The apparatus 602 may be floating on the DC voltage.

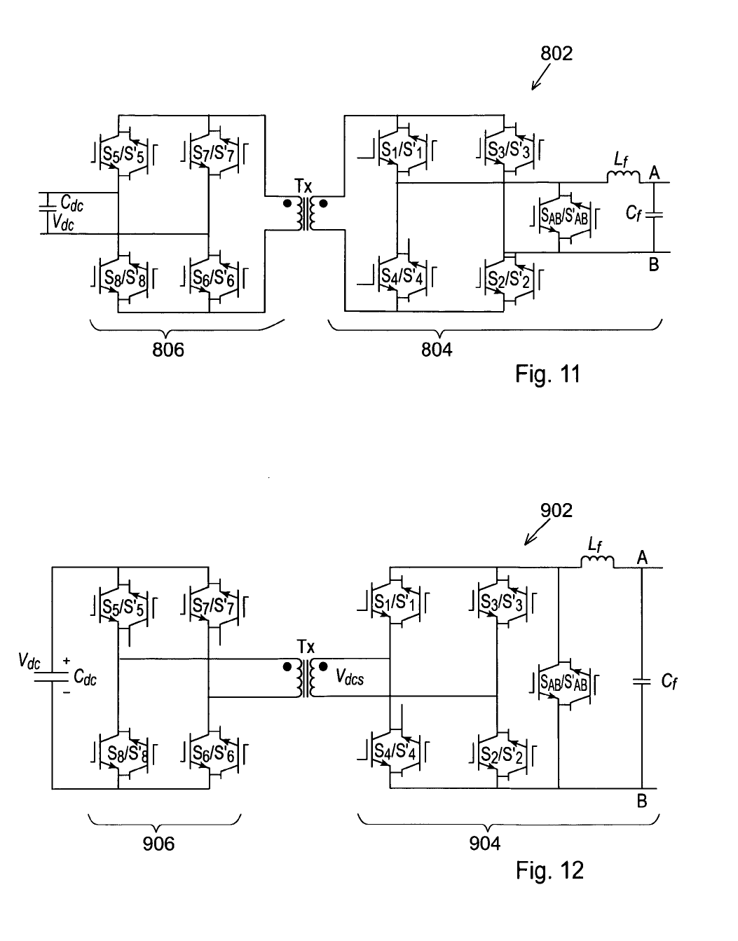

FIGS. 11 and 12 schematically illustrates two further embodiments of the apparatus 802, 902 according to the present invention for controlling the electric power transmission in a HVDC power transmission system, e.g. as shown in FIG. 1. Each apparatus 802, 902 comprises a first converter 804, 904 for converting alternating current to direct current and/or direct current to alternating current, and a second converter 806, 906 for converting direct current to alternating current and/or alternating current to direct current. The components Tₓ, L_{f}, C_{f}, C_{dc}, S_{AB} and S′_{AB} of the apparatuses 802 and 902 may correspond to the corresponding components Tₓ, L_{f}, C_{f}, C_{dc}, S_{AB} and S′_{AB} of FIG. 4 disclosed above, and the components S₁-S₈ and S′₁-S′₈ of the apparatuses 802 and 902 may correspond to the components S₁-S₄ and S′₁-S′₄ of FIG. 4 disclosed above. The interconnection of the components Tₓ, L_{f}, C_{f}, C_{dc}, S_{AB}, S′_{AB}, S₁-S₈ and S′₁-S′₈ of the two apparatuses 802 and 902, respectively, is schematically illustrated in FIGS. 11 and 12. Each apparatus 802, 902 of FIGS. 11 and 12 may be adapted to be connected to a HVDC transmission line and to a DC source as disclosed for the embodiment shown in FIGS. 3 and 4.

Instead of a pair of anti-parallel transistors, e.g. IGBT, used in the embodiments described above, a pair of anti-series transistors, e.g. IGBT or BIGT, as shown in FIGS. 10A and 10B may be used. The advantage of the anti-series connection is that reverse blocking transistors are not required.

Each of the above-mentioned electronic control switches may comprise a transistor, e.g. an IGBT, a BIGT or any other suitable transistor. Alternatively, each of the above-mentioned electronic control switches may comprise a thyristor, e.g. a GTO, an IGCT, or a Forced Commutated Thyristor.

The invention shall not be considered limited to the embodiments illustrated, but can be modified and altered in many ways by one skilled in the art, without departing from the scope the appended claims. For example, the disclosed embodiments may be combined in various possible ways, and additional electric equipment, devices or units may be connected to and between the components of the embodiments.

1.-23. (canceled)

24. An apparatus for controlling the electric power transmission in a high voltage direct current, HVDC, power transmission system comprising at least one HVDC transmission line for carrying direct current, DC, said system forming a DC grid, wherein the apparatus comprises a first converter for converting alternating current, AC, to direct current and/or direct current to alternating current and
a second converter for converting direct current to alternating current and alternating current to direct current,
each of the first and second converters having an AC side for output and/or input of alternating current and a DC side for output and/or input of direct current, the first converter is connectable via its DC side to the HVDC transmission line and the AC side of the second converter is connected to the AC side of the first converter, wherein the apparatus is further adapted to control the direct current of the HVDC transmission line by introducing a DC voltage in series with the HVDC transmission line, wherein the second converter is adapted to provide, directly or by way of a high frequency transformer connected between the first and the second converter, alternating current to the AC side of the first converter, and/or vice versa, and wherein the second converter is connectable via its DC side to a DC source.

25. An apparatus according to claim 24, wherein the apparatus comprises control means for controlling the apparatus, wherein the control means are adapted to control the apparatus to introduce a positive DC voltage in series with the HVDC transmission line for reducing the direct current of the HVDC transmission line, and wherein the control means are adapted to control the apparatus to introduce a negative DC voltage in series with the HVDC transmission line for increasing the direct current of the HVDC transmission line.

26. An apparatus according to claim 24, wherein the apparatus comprises a bypass switch connectable to the HVDC transmission line and connected in parallel with the first converter, and wherein when closed the bypass switch is adapted to conduct the direct current of the HVDC transmission line to electrically bypass the first converter.

27. An apparatus according to claim 24, wherein the apparatus comprises the DC source to which the second converter is connected via its DC side.

28. An apparatus according to claim 24, wherein the apparatus is adapted to be connected to a DC source comprising a first cascaded half-bridge cell, to which the second converter is connectable via its DC side.

29. An apparatus according to claim 28, wherein the first cascaded half-bridge cell is adapted to be part of a converter station included in the HVDC power transmission system, the converter station being adapted to convert AC to direct current, for input to the HVDC transmission line, and/or direct current to alternating current.

30. An apparatus according to claim 28, wherein the apparatus is adapted to be connected to a DC source comprising a plurality of cascaded half-bridge cells to which the first cascaded half-bridge cell is connectable.

31. An apparatus according to claim 30, wherein the plurality of cascaded half-bridge cells are adapted to be part of a converter station included in the HVDC power transmission system.

32. An apparatus according to claim 24, wherein the second converter comprises a Voltage Source Converter, VSC.

33. An apparatus according to claim 24, wherein the second converter comprises four pairs of electronic control devices, each pair of electronic control devices comprising an electronic control switch and a diode.

34. An apparatus according to claim 24, wherein the first converter comprises a full-bridge converter.

35. An apparatus according to claim 24, wherein the apparatus comprises an electric power transformer connected between the first and second converters, and wherein each of the first and second converters is connectable via its AC side to the electric power transformer.

36. An apparatus according to claim 35, wherein the electric power transformer is adapted to isolate the first converter from the DC source.

37. An apparatus according to claim 35, wherein the second converter is adapted to convert DC voltage to high frequency AC voltage.

38. An apparatus according to claim 24, wherein the first converter comprises four pairs of electronic control switches.

39. An apparatus according to claim 38, wherein the first converter comprises a fifth pair of electronic control switches.

40. An apparatus according to claim 38, wherein the first converter comprises filter means for smoothing out the voltage and current ripple caused by the switching of the electronic control switches.

41. An apparatus according to claim 33, wherein each electronic control switch comprises a transistor.

42. An apparatus according to claim 24, wherein the first converter is connectable in series with the HVDC transmission line.

43. A high voltage direct current, HVDC, power transmission system comprising at least one HVDC transmission line for carrying direct current, DC, and a plurality of converter stations connected to the at least one HVDC transmission line, each of the converter stations being adapted to convert alternating current, AC, to direct current for input to the at least one HVDC transmission line, and/or direct current to alternating current, wherein the system comprises at least one apparatus as claimed in claim 24 for controlling the electric power transmission in the system.

44. A HVDC power transmission system according to claim 43, wherein the system comprises a plurality of HVDC transmission lines.

45. A HVDC power transmission system according to claim 43, wherein the system comprises at least three converter stations.

46. A HVDC power transmission system according to claim 43, wherein at least one HVDC transmission line comprises at least one long-distance HVDC link.
